(19) United States
(12) Patent Application Publication
(10) Pub. No.: US 2003/0097773 A1
(43) Pub. Date: May 29, 2003

(54) Three-dimensional card

(76) Inventor: Young Keun Oh, Seoul (KR)

Correspondence Address: HARNESS, DICKEY & PIERCE, P.L.C., P.O. BOX 8910, RESTON, VA, 20195, US

(21) Appl. No.: 10/103,865

(22) Filed: Mar. 25, 2002

(30) Foreign Application Priority Data
Nov. 28, 2001 (KR) 2001-74695
Jan. 31, 2002 (KR) 2002-3084
Mar. 14, 2002 (KR) 2002-7525

(51) Int. Cl. G09F 1/00

(52) U.S. Cl. 40/124.08

(57) ABSTRACT

A three-dimensional card comprises a first plane; a second plane; and an assembly member, said planes being folded each other through central fold line, and said assembly member forming a three-dimensional shape by folding and combining a plurality of assembly pieces mounted on the surface of said first plane and separated along precut cutting lines. A three-dimensional card according to the present invention enables user to laminate at least one plane onto one or more assembly pieces formed by cutting an assembly member, thereby to manufacture a model having similar shape but smaller size than original object.

### FIELD OF THE INVENTION

The present invention relates to a three-dimensional card, and more particularly to a three-dimensional card which enables user to laminate at least one plane onto one or more assembly pieces formed by cutting an assembly member, thereby to manufacture a model having similar shape but smaller size than original object.

### BACKGROUND OF THE INVENTION

In general, a person brings up the image of cards used on special occasion such as Christmas as three-dimensional card. Christmas cards are usually composed of two planes (a first plane and a second plane) to be divided by folding along the central line of one sheet. Both sides, top side or bottom side of designed paintings and ornaments such as Santa Claus, Christmas tree, candle and flower are attached, fixed or suspended on the first and second planes. So, when the card is unfolded, the designed paintings and ornaments appear to be in a three-dimensional shape between the first and second planes.

In another three-dimensional card, designed paintings and ornaments are folded into and out of the planes repeatedly, and the folded top plane and bottom plane are attached on the first and second planes of card. So, when the card is unfolded, the designed paintings and ornaments appeared to be in a three-dimensional shape between the first and second planes. However, the above common cards can simply present the function as greeting cards to the recipient, but not produce any effects of advertisement through three-dimensional article of card.

### SUMMARY OF THE INVENTION

Accordingly, it is an object of the present invention to provide a three-dimensional card which enables user to manufacture a model by mutually combining a plurality of planes. It is another object of the present invention to provide a three-dimensional card capable of displaying and readily assembling three-dimensional models, regardless of its size and shape. It is a further object of the present invention to provide a three-dimensional card capable of advertising a model to be presented as a three-dimensional article.

### BRIEF DESCRIPTION OF THE DRAWINGS

FIG. 1 is an exploded perspective view of a first embodiment of three-dimensional card according to the present invention.

FIG. 2 is an exploded perspective view of a second embodiment of three-dimensional card according to the present invention.

FIG. 3 is an exploded perspective view of a third embodiment of three-dimensional card according to the present invention.

FIG. 4 is an exploded perspective view of a fourth embodiment of three-dimensional card according to the present invention.

FIG. 5 is an exploded perspective view of a fifth embodiment of three-dimensional card according to the present invention.

FIG. 6 is an exploded perspective view of a sixth embodiment of three-dimensional card according to the present invention.

FIG. 7 is a perspective view showing the assembly of FIG. 6.

FIG. 8 is an exploded perspective view of a seventh embodiment of three-dimensional card according to the present invention.

FIG. 9 is a perspective view showing the assembly of FIG. 8.

FIG. 10 is an exploded perspective view of an eighth embodiment of three-dimensional card according to the present invention.

FIG. 11 is an exploded perspective view of a ninth embodiment of three-dimensional card according to the present invention.

FIG. 12 is an exploded perspective view of a tenth embodiment of three-dimensional card according to the present invention.

FIG. 13 is an exploded perspective view of an eleventh embodiment of three-dimensional card according to the present invention.

### DESCRIPTION OF THE PREFERRED EMBODIMENTS

The three-dimensional card according to the present invention comprises a first plane; a second plane; and an assembly member, said planes being folded each other through central fold line, and said assembly member 22 forming a three-dimensional shape by folding and combining a plurality of assembly pieces mounted on the surface of said first plane and separated along precut cutting lines.

The three-dimensional card according to the present invention comprises assembly pieces; a first plane; a second plane; and a fixing member, said planes being folded each other through central fold line, said fixing member being folded vertically out of the bottom of said first plane along precut cutting lines and a plurality of fixing recesses being formed at the top end thereof, and said assembly pieces being vertically combined with said fixing recess.

The three-dimensional card according to the present invention comprises a first plane; a second plane; and an assembly member, said planes being folded each other through central fold line, and said assembly pieces forming a three-dimensional shape by folding and combining around one side face of lower end of said assembly pieces mounted on the surface of said first plane and separated along precut cutting lines.

Hereinafter, embodiments of the present invention will be described, with reference to the accompanying drawings.

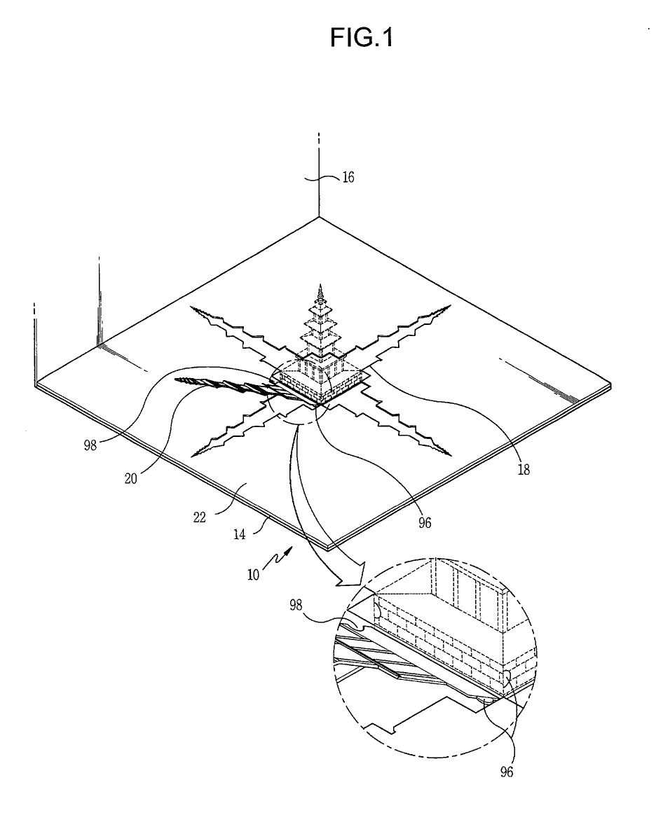

With reference to FIG. 1, the three-dimensional card comprises a first plane 14; a second plane 16; and an assembly member 22, said planes being folded each other through central fold line 12 formed at the central line of three-dimensional card 10, and said assembly pieces 20 being separated along precut cutting lines 18, and said assembly member 22 forming a three-dimensional shape by combining a plurality of assembly pieces 20 mounted on the surface of said first plane 14 and separated along precut cutting lines 18.

One or more first connecting pieces 96 to be combined with adjacent assembly pieces 20 are formed on one side of assembly pieces 20, and one or more first connecting recesses 98 are inserted into the first connecting pieces 96 of adjacent assembly pieces 20 on the other side of assembly pieces 20.

Thus, user of the three-dimensional card according to the present invention can manufacture a model in three-dimensional shape by taking away the assembly pieces 20 from the assembly member 22 and folding (e.g. into and out of the plane) around the cutting lines 18.

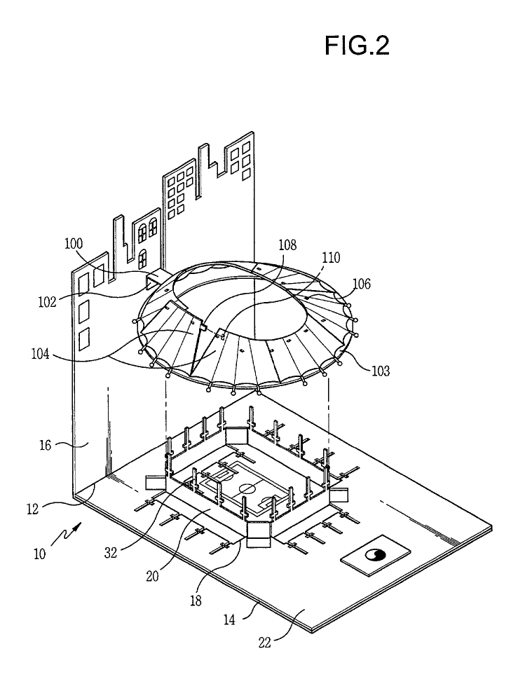

Finally, when the first connecting pieces 96 included in the assembly pieces 20 are inserted into the first connecting recesses 98, pagoda-shaped model as shown in FIG. 1 can be manufactured. First connecting recesses 98 can be slot form as shown in FIG. 2.

With reference to FIG. 2, three-dimensional card comprises a first plane 14; a second plane 16; an assembly member 22; and at least one linker 100, said planes being folded each other through central fold line 12 formed at the central line of three-dimensional card 10, said assembly member 22 forming a three-dimensional shape by folding and combining a plurality of assembly pieces 20 mounted on the surface of said first plane and separated along precut cutting lines 18, and one side of said linker 100 being combined with the assembly pieces 20 to form a certain of three-dimensional shape and the other side of said linker 100 being affixed to said second plane 16 to maintain a certain angle between said first plane 14 and second plane 16.

Fixing piece 102 is affixed to the first plane 14 on one side of linker 100, and dome-shaped combining member 103 is connected to the upper section of assembly put together by the assembly pieces 20 on the other side of linker 100. Also, a plurality of combining slots 106 are formed around the combining member 103 so that a plurality of assembly pins 32 projected upward from the assembly pieces 20 are penetrated through the combining slots 106 to form an assembly body. Linker 100 has a fixing piece 115 to be attached to the first plane 16.

Also, a plurality of combining pieces 104 are formed on the dome-shaped combining member 103. Second combining pieces 108 inserted into adjacent combining pieces 104 are formed on the combining pieces 104.

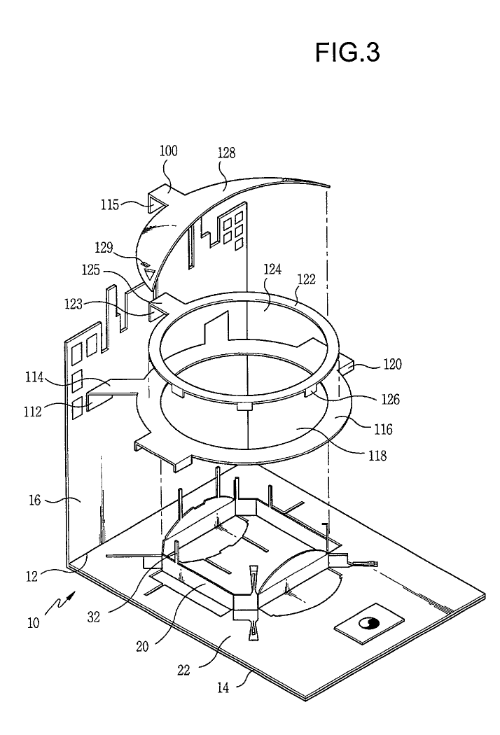

With reference to FIG. 3, the three-dimensional card comprises a first plane 14; a second plane 16; an assembly member 22; and at least one linker 100, said planes being folded each other through central fold line 12 formed at the central line of three-dimensional card 10, said assembly member 22 forming a three-dimensional shape by folding and combining a plurality of assembly pieces mounted on the surface of said first plane 14 and separated along precut cutting lines 18, and one side of said linker 100 being combined with said assembly pieces 20 to form a certain of three-dimensional shape and the other side of said linker 100 being affixed to said second plane 16 to maintain a certain angle between said first plane 14 and second plane 16. Fixing piece 102 is affixed to the first plane 14 on one side of linker 100 and dome-shaped combining member 128 is combined to the upper section of assembly put together by the assembly pieces 20 on the other side of linker 100. Combining slots 129 are formed on both side ends of the dome-shaped combining member 128. A plurality of assembly pins 32 projected upward from the assembly pieces 20 are penetrated through the combining slots 129 to form an assembly body. Linker 100 has a fixing piece 115 to be attached to the first plane 16.

Also, a plurality of connecting members 116 and 122 are inserted between the linker 100 and assembly pieces 20 so as to maintain a certain of interval therebetween, thereby to form a three-dimensional shape. In this case, connecting members 116 and 122 further comprise linkers 114 and 125 affixed to the first plane 16, interval maintainers 120 and 126, and insert holes 118 and 124.

Representative examples of three-dimensional shape capable of manufacturing in accordance with embodiment of FIG. 3 include Gwangju, Daegu and Jeju World Cup stadiums.

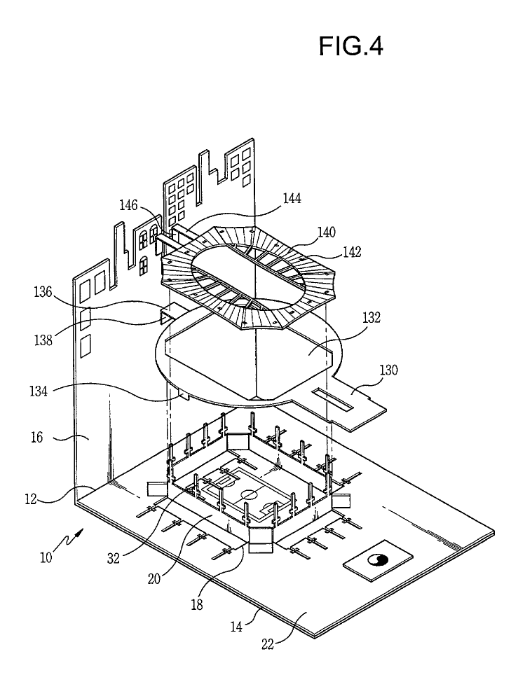

With reference to FIG. 4, the three-dimensional card comprises a first plane 14; a second plane 16; an assembly member 22; and at least one linker 144, said planes being folded each other through central fold line 12 formed at the central line of three-dimensional card 10, said assembly member 22 forming a three-dimensional shape by folding and combining a plurality of assembly pieces 20 mounted on the surface of said first plane 14 and separated along precut cutting lines 18, and one side of said linker 144 being combined with said assembly pieces 20 to form a certain of three-dimensional shape and the other side of said linker 144 being affixed to said second plane 16 to maintain a certain angle between said first plane 14 and second plane 16. Fixing piece 146 is affixed to the first plane 14 on one side of linker 144 and dome-shaped combining member 140 is connected to the upper section of assembly put together by the assembly pieces 20 on the other side of linker 144. A plurality of assembly pins 32 projected upward from the assembly pieces 20 are penetrated through combining slots 142 via an insert hole 132 of the combining member 140 to form an assembly body.

In this case, combining member 140 is inserted between the linker 144 and assembly pieces 20 so as to maintain a certain of interval therebetween, thereby to form a three-dimensional shape. Also, additional combining member 130 is mounted between the combining member 140 and assembly pieces 20 to maintain a certain of interval therebetween, thereby to form a three-dimensional shape. Insert hole 132, an interval maintainer 134, a linker 136 and a fixing piece 138 are formed on the connecting member 130.

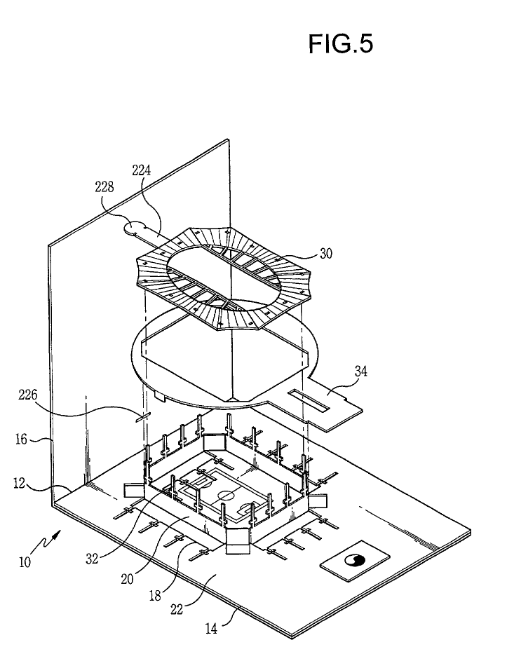

With reference to FIG. 5, the three-dimensional card comprises a first plane 14; a second plane 16; an assembly member 22; and at least one support member 24, said planes being folded each other through central fold line 12 formed at the central line of three-dimensional card 10, said assembly member 22 forming a three-dimensional shape by folding and combining a plurality of assembly pieces 20 mounted on the surface of said first plane 14 and separated along precut cutting lines 18, and one side of said support member 24 being combined with said assembly pieces 20 to form a certain of three-dimensional shape and the other side of said support member 24 being detachably affixed to said second plane 16 to maintain a certain angle between said first plane 14 and second plane 16.

In this case, fixing protrusion 228 a little larger in size than an insert hole 226 formed on the second plane 16 is formed on one side of linker 224 so that the fixing protrusion 228 can be inserted into the insert hole 226 to fix to the second plane 16.

Also, dome is connected to the upper section of assembly put together by the assembly pieces 20 on the other side of linker 224. A plurality of combining slots 30 are formed around the dome and a plurality of assembly pins 32 projected upward from the assembly pieces 20 are penetrated through the combining slots 30 to form an assembly body.

In this case, connecting member 34 are inserted between the linker 224 and the assembly pieces 20 so as to maintain a certain of interval therebetween, thereby to form a three-dimensional shape.

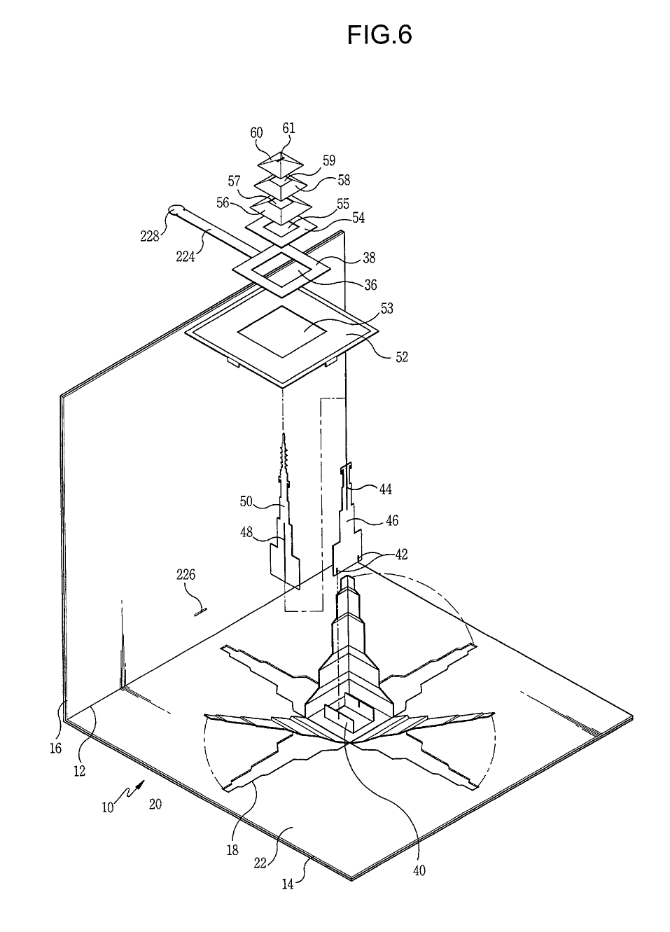

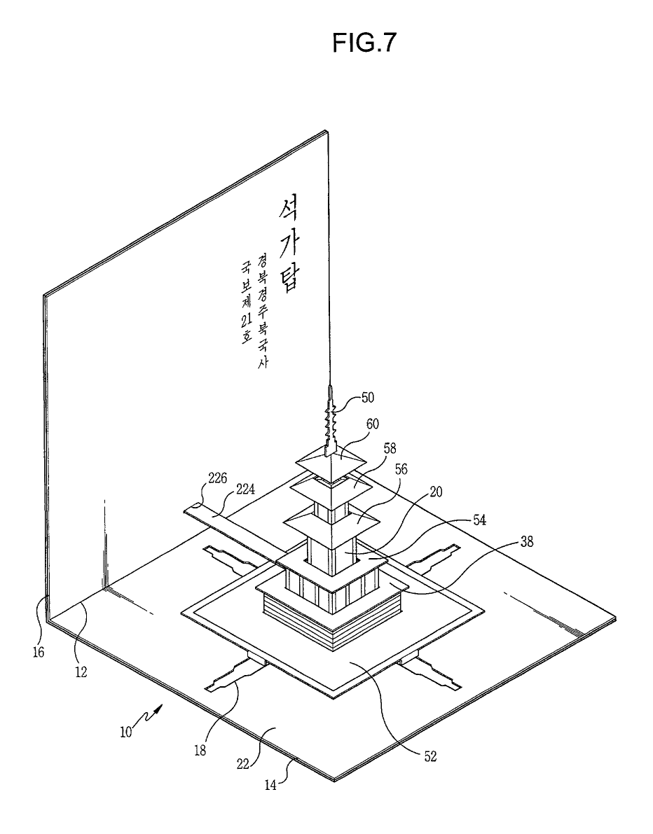

With reference to FIG. 6 and FIG. 7, the three-dimensional card comprises a first plane 14; a second plane 16; an assembly member 22; and a linker 224, said planes being folded each other through central fold line 12, said assembly member 22 forming a three-dimensional shape by folding and combining a plurality of assembly pieces 20 mounted on the surface of said first plane 14 and separated along precut cutting lines 18, and said linker 224 comprising a fixing protrusion 228 which combines with an insert hole 26 of said second plane 16 so as to connect said assembly pieces 20 with said second plane 16.

Also, rectangular ring 38 is formed in the inside of linker 224 having an insert hole 36. Assembly pieces 20 of the assembly member are penetrated into the insert hole 36 to support and maintain a certain of shape.

On the other hand, support means in the inside of assembly body formed by the combined assembly pieces 20 is connected to a vertical fixing plate 40 which is folded out of the bottom of the assembly member 22. Support means is assembled with the assembly pieces 20 in a body to form a three-dimensional shape having its rigidity.

Support means comprises a lower support plate 46 and an upper support plate 50. Fixing recess 42 affixed to the fixing plate 40 is formed at the lower end portion of the lower support plate 46, and a first vertical recess 44 with a certain of length is formed at the top end portion of the lower support plate 46. Second vertical recess 48 corresponding to the first vertical recess 44 is formed at the lower end portion of the upper support plate 50 so as to cross with the upper support plate 50.

That is, support means for maintaining its rigidity is mounted in the inside of assembly body formed by the assembly pieces, and a plurality of combining members 52, 54, 56, 58 and 60 at the upper and lower sides of linker 24 are mounted in the outside of assembly body so that assembly pieces 20 are tightly combined.

Combining members have insert holes 53, 55, 57, 59 and 61 corresponding to the shape of assembly body so that the assembly pieces 20 of assembly member are folded upward to form a three-dimensional shape.

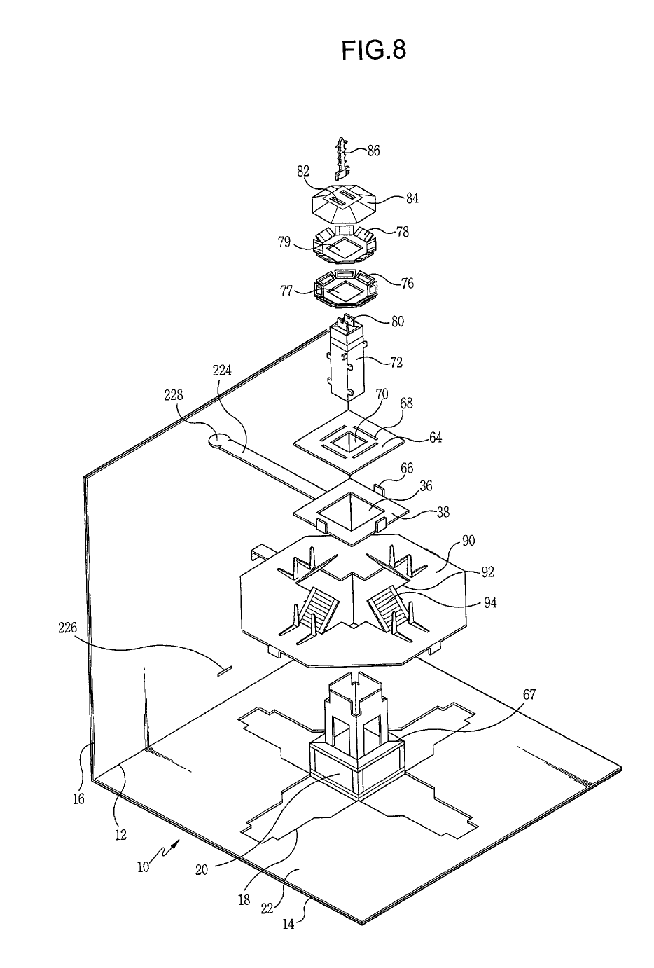

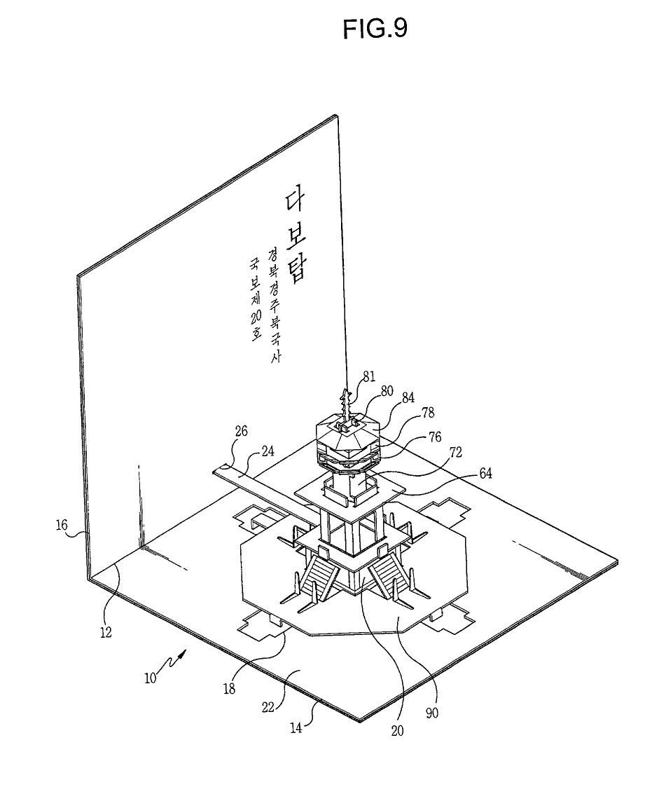

With reference to FIGS. 8 and 9, the three-dimensional card comprises a first plane 14; a second plane 16; an assembly member 22; linker 224; and support means, said planes being folded each other through central fold line 12, said assembly member 22 forming a three-dimensional shape by folding and combining a plurality of assembly pieces 20 mounted on the surface of the first plane 14 and separated along precut cutting lines 18, said linker 224 comprising a fixing protrusion 228 which combines with an insert hole 26 of said second plane 16 so as to connect said assembly pieces 20 with said second plane 16, and said support means being mounted through separate fixing plane 64 affixed to the upper section of said assembly pieces 20.

In this case, a plurality of vertical protrusions 66 on the peripheral portion of linker 224 project upward, and an insert hole 36 is formed in the center of linker 224 so as to be inserted into the outer circumference of assembly body formed by the assembly pieces 20 and to be affixed to a shoulder 67.

Fixing plane 64 has a plurality of fixing slots 68 for fixing the front end portions of assembly pieces 20, and is affixed to its upper section by inserting the front end portions of assembly body formed by the assembly pieces 20 into the fixing slots 68.

On the other hand, insert hole 70 in the center of fixing plane 64 is formed so that column-shaped support means is inserted thereinto.

Support means is preferably a support assembly 72 which is assembled in the shape of column having a certain of length by a plurality of planar members. A plurality of combining members 76 and 78 are combined to the outer circumference of support assembly 72. Insert holes 77 and 79 are formed in the center of combining members 76 and 78 so that support assembly 72 can be inserted thereinto and form a three-dimensional shape.

On the other hand, a pair of parallel protrusions 80 is formed on the top end portion of support assembly 72, and the protrusions 80 are combined to combining member 84 having insert holes 82.

Also, pinnacle 86 having a certain of shape is mounted on the end portion of protrusions 80 projected through the insert holes 82.

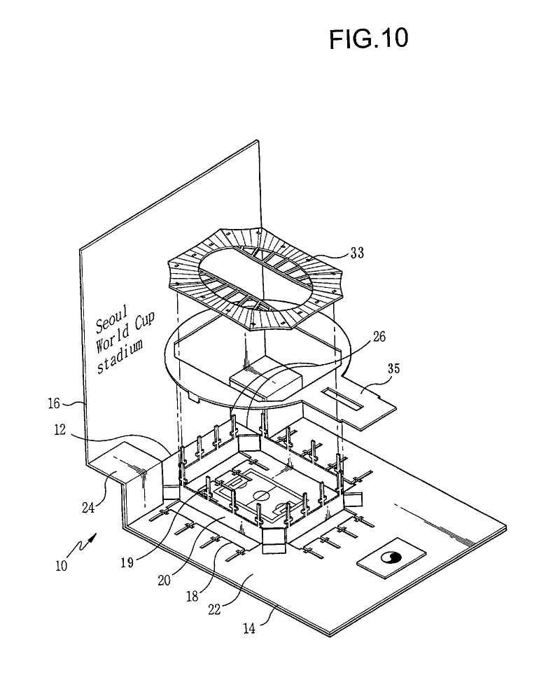

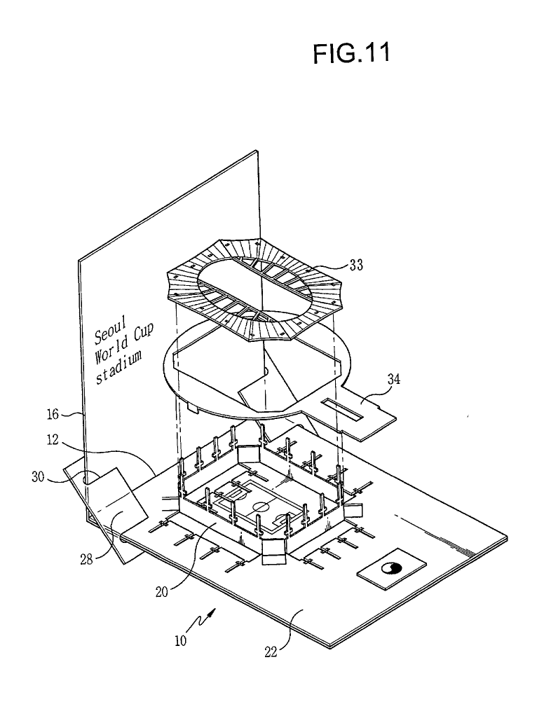

On the other hand, second assembly member 94 is combined to the bottom of an assembly body formed by the combined assembly pieces 20, and the assembly body is assembled with a second assembly body 94 formed along precut cutting lines to form a final assembly body. With reference to FIGS. 10 and 11, the three-dimensional card comprises a first plane 14; a second plane 16; an assembly member 22; and support members 24, said planes being folded each other through central fold line 12, said assembly member 22 forming a three-dimensional shape by folding and combining a plurality of assembly pieces 20 mounted on the surface of said first plane and separated along precut cutting lines 18, said support members 24 for maintaining a certain angle between said first plane 14 and second plane 16.

In this case, support members 24 has incised lines 26 with a certain of length away from central fold line 12 and an internal fold line which extends horizontally from the end of incised lines 26 to the ends of the first plane 14 and second plane 16. When the first plane 14 and second plane 16 are unfolded, both ends from incised lines 26 are folded by the internal fold line so as to maintain a certain angle between the first plane 14 and second plane 16.

Also, support members 24 can be support members 28 as shown in FIG. 11. That is, a plurality of first fixing recesses 30 are formed on the one side end portion of the support members 28 and inserted between the first plane 14 and second plane 16 to maintain a certain angle between the planes 14 and 16.

Also, dome is connected to the upper section of assembly put together by the assembly pieces 20. A plurality of combining slots 33 are formed around the dome and a plurality of assembly pins 19 projected upward from assembly pieces 20 are penetrated through the combining slots 33 to form an assembly body.

In this case, connecting member 35 is inserted between the assembly pieces 20 and maintains a certain interval between the assembly pieces 20 to form a three-dimensional shape.

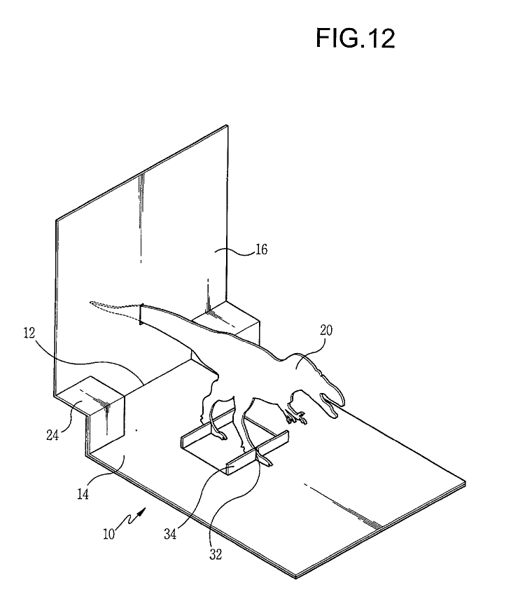

With reference to FIG. 12, the three-dimensional card comprises assembly pieces 20; a first plane 14; a second plane 16; a fixing member 34; and support members 24 for maintaining a certain angle between said first plane 14 and second plane 16, said planes being folded each other through central fold line 12, and said fixing member 34 being folded upward from the bottom of said first plane 14, a plurality of second fixing recesses 32 being formed on its top end and said assembly pieces 20 being combined to the second fixing recesses 32.

In this case, support members 24 has incised lines 26 with a certain of length away from central fold line 12 and an internal fold line which extends horizontally from the end of the incised lines 26 to the ends of the first plane 14 and second plane 16. When the first plane 14 and second plane 16 are unfolded, both ends from the incised lines 26 are folded by the internal fold line so as to maintain a certain angle between the first plane 14 and second plane 16.

Also, support members 24 can be support members 28 as shown in FIG. 11. That is, a plurality of first fixing recesses 30 are formed on the one side end portion of the support members 28 and inserted between the first plane 14 and second plane 16 to maintain a certain angle between the planes 14 and 16.

Assembly pieces are inserted into second fixing recesses 32 of a fixing member 34, and the assembly pieces inserted into the second fixing recesses 32 are folded and combined to form a body.

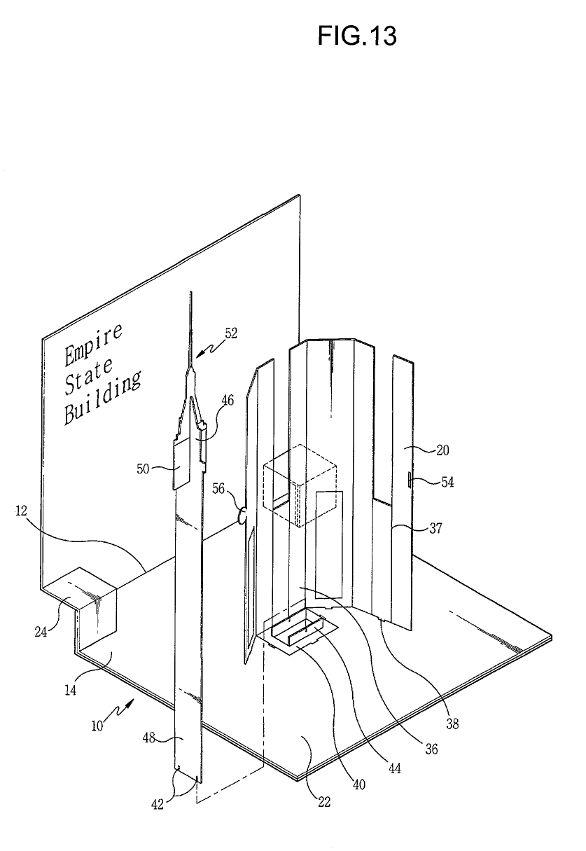

With reference to FIG. 13, the three-dimensional card comprises a first plane 14; a second plane 16; an assembly member 22; support members 24; linkers 38, said planes being folded each other through central fold line 12, said assembly member 22 being mounted on the surface of said first plane and forming a three-dimensional shape by combining around the lower one side of assembly pieces 20 separated along precut cutting lines 18, said support members 24 having incised lines 26 with a certain of length away from the central fold line 12 and an internal fold line which extends horizontally from the end of said incised lines 26 to the end of said first plane 14 and second plane 16, the one side of said linker 38 being combined to said assembly member 22 and the other side of said linker 38 being detachably affixed to said first plane 14 so that the assembly pieces 20 are affixed to said first plane 14.

Linkers 38, which are detachable fixing protrusions, are inserted into an insert hole 40 of the first plane 14.

In this case, one lower side face 36 is folded from the bottom of the assembly member 22, and the other side faces are separated from the assembly member 22, folded along fold lines 37 and combined in a body to form a three-dimensional shape.

Particularly, the three-dimensional card of the present invention further comprises support means wherein the combined assembly pieces 20 of the assembly member 22 are deeply inserted to maintain the rigidity of three-dimensional shape.

Support means is combined to fixing plates 44 curved from the bottom of the assembly member 22.

Support means comprises a lower support plate 48 and an upper support plate 52. Third fixing recesses 42 affixed to the fixing plate 44 are formed at the lower end portion of the lower support plate 48 and a second vertical recess 50 formed on the upper support plate 52 corresponding to a first vertical recess 46 is formed at the top end portion of the lower support plate 48 so as to cross-combine with the lower support plate 48.

Also, support members 24 can be support members 28 as shown in FIG. 11. That is, a plurality of first fixing recesses 30 are formed on the one side end portion of the support members 28 and inserted between the first plane 14 and second plane 16 to maintain a certain angle between the planes 14 and 16.

As described above, the present invention enables user of three-dimensional card to manufacture a model by combining a plurality of planes one another.

The present invention provides a model obtainable by constituting assembly body using assembly pieces together with linker and then combining fixing protrusion which extends from linker with insert hole of second plane, thereby placing the second plane of the three-dimensional card at the rear of assembly body. Also, background image or character related to the assembly body can be expressed through the second plane, thus advertising a model to be presented as a three-dimensional article.

Further, the present invention enables user of three-dimensional card to readily assemble a model by combining a plurality of planes.

It is to be understood that the present invention is not limited to the embodiments described above, but encompasses any and all embodiments within the scope of the following claims.

We claim:

1. A three-dimensional card comprising a first plane; a second plane; and an assembly member, said planes being folded each other through central fold line, and said assembly member forming a three-dimensional shape by folding and combining a plurality of assembly pieces mounted on the surface of said first plane and separated along precut cutting lines.

2. A three-dimensional card comprising assembly pieces; a first plane; a second plane; and a fixing member, said planes being folded each other through central fold line, said fixing member being folded vertically out of the bottom of said first plane along precut cutting lines and a plurality of fixing recesses being formed at the top end thereof, and said assembly pieces being vertically combined with said fixing recess.

3. A three-dimensional card comprising a first plane; a second plane; and an assembly member, said planes being folded each other through central fold line, and said assembly pieces forming a three-dimensional shape by folding and combining around one side face of lower end of said assembly pieces mounted on the surface of said first plane and separated along precut cutting lines.

4. The three-dimensional card according to any one of claims 1 to 3, wherein one side of said support member is combined with said assembly pieces to form a certain of three-dimensional shape and the other side of said support member is detachably affixed to said second plane to maintain a certain angle between said first plane and second plane.

5. The three-dimensional card according to claim 4, wherein said support member is attached to said first plane.

6. The three-dimensional card according to claim 4, wherein said support member comprises a fixing protrusion a little larger in size than an insert hole formed on the second plane so that the fixing protrusion can be inserted into and detachably affixed to the insert hole fix to the second plane.

7. The three-dimensional card according to claim 4, wherein said linker comprises at least one combining slot for supporting an assembly body by penetrating through the assembly body of assembly member.

8. The three-dimensional card according to any one of claims 1 to 3, wherein said support member has incised lines with a certain of length away from central fold line and a internal fold line which extends horizontally from the end of incised lines to the ends of said first plane and second plane so that when said first plane and second plane are unfolded, both ends from incised lines are folded by said internal fold line to maintain a certain angle between said first plane and second plane.

9. The three-dimensional card according to any one of claims 1 to 3, wherein said support member has a plurality of first fixing recesses formed on its one side end portion, said first fixing recesses being inserted between said first plane and second plane to maintain a certain angle therebetween.

10. The three-dimensional card according to claim 1, wherein one or more first connecting pieces to be combined with adjacent assembly piece are formed on one side of said assembly pieces, and one or more first connecting recesses are inserted into said first connecting pieces of adjacent assembly pieces on the other side of said assembly pieces.

11. The three-dimensional card according to claim 1, further comprising at least one connecting member forming a certain of three-dimensional shape by assembling the combined assemble pieces of assembly member therewith and having a certain of insert hole for maintaining a certain of form by inserting said assembly pieces into said connecting member.

12. The three-dimensional card according to claim 11, further comprising support means in which the combined assembly pieces of said assembly member are deeply inserted and assembled with said assembly pieces and said connecting member in a body to maintain the rigidity of three-dimensional shape.

13. The three-dimensional card according to claim 12, wherein said support means is connected to a vertical fixing plate folded out of the bottom of said assembly member.

14. The three-dimensional card according to claim 13, wherein said support means comprises a lower support plate and an upper support plate, a fixing recess affixed to said fixing plate being formed at the lower end portion of said lower support plate, a first vertical recess with a certain of length being formed at the top end portion of said lower support plate, and a second vertical recess corresponding to said first vertical recess being formed at the lower end portion of said upper support plate so as to cross with said upper support plate.

15. The three-dimensional card according to claim 11, wherein said support means is mounted on the upper section of said assembly member through separate fixing plate to be assembled at said assembly member.

16. The three-dimensional card according to claim 15, wherein said support means is formed in the shape of column using a plurality of planar members and inserted into a hole at the center of said fixing plane.

17. The three-dimensional card according to claim 13 or claim 16, wherein a plurality of assembly pieces which are formed separately are connected to the upper section of said support means.
